(19) United States
(12) Patent Application Publication
(10) Pub. No.: US 2003/0200088 A1
(43) Pub. Date: Oct. 23, 2003

(54) Electronic bookmark dictionary

(75) Inventor: Pat Tsao, Clifton, VA (US)

Correspondence Address: Ladas & Parry, 26 West 61 Street, New York, NY, 10023, US

(73) Assignee: INTECS INTERNATIONAL, INC.

(21) Appl. No.: 10/125,637

(22) Filed: Apr. 18, 2002

(51) Int. Cl. G10L 15/00

(52) U.S. Cl. 704/251

(57) ABSTRACT

An electronic bookmark dictionary, comprising: a voice input device for receiving a voice input signal; a voice recognition device, coupled to the voice input device, for recognizing the received voice input signal and generating at least one recognized word or word string; a processor for receiving the at least one recognized word or word string and comparing the at least one recognized word or word string with data in a database so as to locate the corresponding word or word string and its meaning of the at least one recognized word or word string, and an output device, coupled to the processor for outputting the located word or word string and the meaning of the at least one recognized word or word string.

### BACKGROUND OF THE INVENTION

1. Field of the Invention

The invention relates to an electronic dictionary, and in particular to an electronic bookmark dictionary.

2. Description of the Related Art

A conventional electronic dictionary uses a keyboard to input words to be checked, thus the size of the conventional electronic dictionary cannot be reduced. Some manufacturers intend to reduce the size of the keyboard in order to reduce the size of the whole dictionary. However, such keyboard is too small to operate easily. Therefore, the biggest problem of the conventional electronic dictionary lies in that the size of the dictionary cannot be reduced.

Another problem of the conventional electronic dictionary is that it has too many complicated features and is too expensive. Therefore, the conventional electronic dictionary cannot be popularized among students.

### SUMMARY OF THE INVENTION

An aspect of this invention is to provide an electronic bookmark dictionary that adopts voice input or written input, thus a keyboard is unnecessary and the size of the dictionary can be significantly reduced. Particularly, the thickness of the dictionary can be reduced and thus the dictionary can be formed into a bookmarktype dictionary.

### BRIEF DESCRIPTION OF THE DRAWINGS

For a more complete understanding of the present invention and the advantages thereof, reference is now made to the following descriptions taken in conjunction with the accompanying drawings which illustrate the embodiments of the present invention, wherein:

FIG. 1a illustrates a front view of the electronic bookmark dictionary of the present invention;

FIG. 1b illustrates a side view of the electronic bookmark dictionary of the present invention; and

FIG. 2 illustrates a circuit diagram of the electronic bookmark dictionary of the present invention.

### DETAILED DESCRIPTION OF THE PREFERRED EMBODIMENT

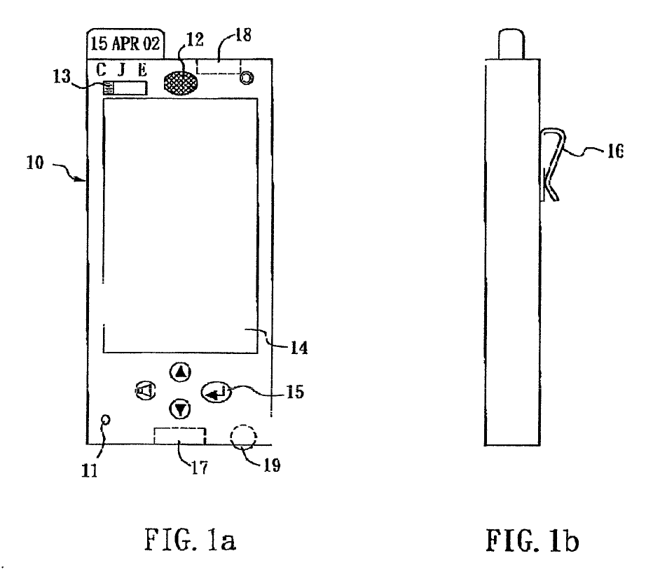

FIGS. 1a and 1b illustrate the schematic diagram of the electronic bookmark dictionary (10) of the present invention. The electronic bookmark dictionary (10) of the present invention comprises at least one input device, such as a voice input device (microphone (11)) or a written input device (23), for receiving the user's voice input signal or written input signal; at least one output device, such as a speaker (12) or a display device (14), for outputting the checking result; a switch (13) for switching the input signal, such as Chinese, English or Japanese input signal; a plurality of buttons (15) for controlling or selecting other functions of the electronic bookmark dictionary (10), such as up, down, left, right or return; a clip (16) for clipping the electronic bookmark dictionary (10) to another object such as a book; an input/output port (17) for downloading or uploading data through a network or a communication device; an expansion slot (18) for expanding the data capacity of the database; and a volume control device (19) for controlling the output volume of the speaker (12).

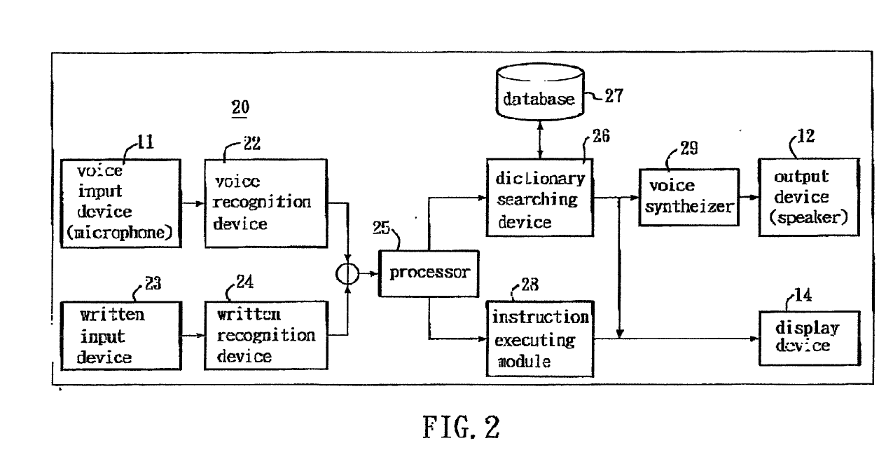

FIG. 2 illustrates a circuit diagram of the electronic bookmark dictionary of the present invention. The operation and the internal circuit structure of the electronic bookmark dictionary (10) are described as follows:

The electronic bookmark dictionary (10) comprises a voice input device (such as a microphone (11)) for receiving a voice input signal, i.e., receiving the word(s) to be checked that is (are) input by voice. A voice recognizing device (22) is coupled to the voice input device (11) for recognizing the received voice input signal or word(s) and generating at least one recognized word or word string. A processor (25) is used to receive the recognized word or word string and transmit the recognized word or word string to a dictionary searching device (26) for comparing the recognized word or word string with data in a database (27) so as to locate the corresponding word or word string and it meaning. The located word or word string and it meaning is displayed on an output device (such as a display device (14)) coupled to the processor (25) or output to the other output device (such as a speaker (12)) after a synthesizing process by a voice syntheizer (29).

The above voice input signal may be in a first language (such as Chinese) and the output signal may be in the same language or a second language (such as English or Japanese). That is to say, different languages can be selected for the electronic dictionary by a switch (13) so it performs the functions of Chinese-Chinese, Chinese-English, or Chinese-Japanese dictionaries.

The electronic bookmark dictionary (10) of the present invention further comprises a written input device (23) for receiving the user's written input signal. The written input signal is recognized by a written recognition device (24) to identify whether the written input signal refers to a word or an instruction. If the written input signal is a word, then the processor (25) performs the checking function as mentioned above. If the written input signal is an instruction, then the processor (25) transmits the instruction to an instruction executing module (28) to perform a corresponding process. In addition, the written input device (23) can be integrated into the output device (display device (14)) to form a touch-screen device to facilitate the user's input.

Another embodiment of the present invention relates to an electronic bookmark dictionary that only uses a written input device as an input device. The structure of this embodiment is similar to the first embodiment of the present invention except for the voice input device, and thus is not redundantly described.

The present invention provides at electronic bookmark dictionary that adopts voice input and/or written input, thus a keyboard is unnecessary and the size of the dictionary can be significantly reduced. Particularly, the thickness of the dictionary can be reduced and thus the dictionary can be formed into a bookmarktype dictionary which is easily carried and can be popularized among students.

Although the present invention and its advantages have been described in detail, it should be understood that various changes, substitutions and alterations can be made herein without departing from the spirit and scope of the invention as defined by the appended claims.

What is claimed is:

1. An electronic bookmark dictionary, comprising:
a voice input device for receiving a voice input signal;
a voice recognition device, coupled to the voice input device, for recognizing the received voice input signal and generating at least one recognized word or word string;
processor for receiving the at least one recognized word or word string and comparing the at least one recognized word or word string with data in a database so as to locate the corresponding word or word string and the meaning of the at least one recognized word or word string; and
an output device, coupled to the processor for outputting the located word or word string and the meaning of the at least one recognized word or word string.

2. The electronic bookmark dictionary as claimed in claim 1, wherein the voice input device is a microphone.

3. The electronic bookmark dictionary as claimed in claim 1, wherein the voice input signal is in a first language and the outputted corresponding word or word string and the meaning of the at least one recognized word or word string is in a second language.

4. The electronic bookmark dictionary as claimed in claim 1, wherein the voice input signal and the output corresponding word or word string and the meaning of the at least one recognized word or word string are in the same language.

5. The electronic bookmark dictionary as claimed in claim 1, wherein the output device is a display device.

6. The electronic bookmark dictionary as claimed in claim 1, wherein the output device is a speaker for outputting the word or word string and the meaning of the at least one recognized word or word string in a voice manner.

7. The electronic bookmark dictionary as claimed in claim 1, further comprises a voice synthesizer for synthesizing the word or word string and the meaning of the at least one recognized word or word string.

8. The electronic bookmark dictionary as claimed in claim 1, further comprises a written input device for receiving the user's written input signal.

9. The electronic bookmark dictionary as claimed in claim 1, further comprises a written recognition device for recognizing whether the user's written input signal is a word or an instruction.

10. The electronic bookmark dictionary as claimed in claim 1, further comprises all instruction executing module for executing a corresponding process of the instruction.

11. The electronic bookmark dictionary as claimed in claim 1 further comprises a switch for switching between different languages.

12. The electronic bookmark dictionary as claimed in claim 1, further comprises a clip for clipping the electronic bookmark dictionary to another object.

13. The electronic bookmark dictionary as claimed in claim 1, further comprises an input/output port for downloading or uploading data through a network or a communication device.

14. The electronic bookmark dictionary as claimed in claim 1, further comprises an expansion slot for expanding data capacity of the database.

15. The electronic bookmark dictionary as claimed in claim 1, wherein the written input device is integrated into the display device.

16. The electronic bookmark dictionary as claimed in claim 1, further comprises a volume control device for controlling the output volume of the output device.

17. The electronic bookmark dictionary as claimed in claim 1, further comprises a plurality of buttons for controlling or selecting other functions of the electronic bookmark dictionary.

18. An electronic bookmark dictionary, comprising:
a written input device for receiving a user's written input signal;
a written recognition device, coupled to the written input device, for recognizing the received user's written input signal and generating at least one recognized word or instruction;
a processor, coupled to the written recognition device, for executing a word process or an instruction process in response to the recognized word or instruction, wherein the at least one recognized word is compared with data in a database to locate the corresponding word and the meaning of the at least one recognized word when a word process is executed or a corresponding process is executed when an instruction is executed; and
an output device, coupled to the processor for outputting the located word and its meaning of the at least one recognized word or word string or an executed result of the instruction.

19. The electronic bookmark dictionary as claimed in claim 1, further comprises a voice synthesizer for synthesizing the word or word string and the meaning of the at least one recognized word or word string and a speaker for outputting the same.

20. The electronic bookmark dictionary as claimed in claim 1, wherein the written input device is integrated into the output device.
